(19) United States
(12) Patent Application Publication
(10) Pub. No.: US 2006/0225051 A1
(43) Pub. Date: Oct. 5, 2006

(54) Method and system for code coverage

(75) Inventor: Raja Rajaram Kannan, Chennai (IN)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/153,982

(22) Filed: Jun. 16, 2005

(30) Foreign Application Priority Data
Apr. 5, 2005 (IN) 870/DEL2005

(51) Int. Cl. G06F 9/44

(52) U.S. Cl. 717/129

(57) ABSTRACT

A method, a native library and a Java Virtual Machine Debugger Interface agent for providing code coverage for programs coded in a computer language are described. The method involves determining the classes for which the code coverage is desired. The runtime environment for the computer language generates software events for several events that take place in the environment, such as preparing a class for loading and breakpoints. Handler functions for the events corresponding to events such as preparing a class for loading and breakpoints are registered with the runtime environment. The method further involves receiving breakpoints for one or more executable units in the classes for which the code coverage is desired. On receiving the breakpoint event, a line hit counter is incremented, which enables determination of the lines of code which are exercised and which are not. The native library and Java Virtual Machine Debugger Interface agent contain instructions that implement the method.

### BACKGROUND OF THE INVENTION

1. Field of Invention

Embodiments of the invention relate in general to testing of software programs. More specifically, the embodiments of the invention relate to methods and systems for code coverage in programs that are coded using an object oriented programming language.

2. Description of the Background Art

With the advent of Information Technology, software based solutions are being deployed across enterprises. The large-scale deployment of software based solutions leads to an increase in reliance on such systems. Thus, the development of high quality software has become a necessity. Due to the importance of developing high-quality software, defect prevention tools and techniques are assuming importance in the principle of software engineering.

Defects in software programs can get introduced at any phase of the software development lifecycle. For example, defects can get injected at the software design phase or coding phase or in other phases. The testing phase in the software development lifecycle forms an important phase where the injected defects can be detected.

The testing phase involves executing a software program with a number of test cases. The test cases are the conditions under which the software program is expected to execute. These test cases are envisaged at the time of designing the software programs.

The term ‘code coverage’ is used to refer to the process of finding the executable units in the software program that are not exercised by a set of test cases. Also, code coverage helps in creating additional test cases to increase coverage. Further, code coverage may help in identifying the redundant test cases that do not increase coverage. A quantitative measure of code coverage is used as an indirect measure of quality.

Several tools for providing code coverage are known in the art. A technique used by most code coverage tools known in the art is called instrumentation. Instrumentation refers to adding instructions between lines of a program for which code coverage is desired. For an Object Oriented Programming language such as Java®, provided by Sun Microsystems, Inc., broadly three types of code coverage tools are available. The first type of code coverage tools adds instrumentation instructions into the source code for which the code coverage is desired. The second type of code coverage tools adds instrumentation instructions into the Java byte code, i.e., the compiled version of the source programs containing the Java code. Such compiled version of the source programs is available in ‘.class’ files. The third type of code coverage tools executes the programs in a modified Java Virtual Machine (JVM) or Java Runtime Environment (JRE). The JVM or JRE provide the environment for execution of the programs.

The first and second type of code coverage tools requires the program code to which the instrumentation instructions are added to be recompiled. This leads to an increased build time for the software. Also, in such code coverage tools code coverage cannot be provided for the software applications for which the source code is not accessible. Further, if these types of code coverage tools use some third-party libraries, then these libraries need to be included in the class path during both the build and test phases. Version conflict problems may also arise if the software application uses a different version of the same libraries than the version used by the code coverage tools. Further, complications arise if client/server and Java Network Launch Protocol (JNLP) based applications, which are common at enterprise level, are used.

The Java platform provided by Sun Microsystems, Inc. also includes an interface, Java Virtual Machine Debugger Interface (JVMDI) for developing tools such as code coverage tools and debuggers. Several tools based on the JVMDI are known in the art.

One or more of the tools known in the art are complex and heavyweight. This is because one or more of these tools use Java Platform Debugger Architecture (JPDA) by using the Java Debug Interface (JDI) and Java Debug Wire Protocol (JDWP). One or more of the tools depend on the version of the Java Virtual Machine (JVM) for execution. This may lead to incompatibility of these tools with one or more versions of the JVM.

One or more of these tools use JVMDI single step (JVMDI_EVENT_SINGLE_STEP) and method entry/exit (JVMDI_EVENT_METHOD_ENTRY/JVMDI_EVENT_METHOD_EXIT) events to provide code coverage. By using these events it may not be possible to provide class-level inclusion or exclusion support. The use of method entry/exit events provides code coverage for all classes loaded by the thread irrespective of whether such a code coverage is desired or not. This is because these events are global for a thread and are thus generated for all classes loaded by the thread. Thus, use of these events leads to a performance overhead and an increased execution time.

In the light of the above discussion, there exists a need in the art for advanced methods and systems for providing code coverage for programs coded in a computer language.

### BRIEF DESCRIPTION OF THE DRAWINGS

FIG. 1 illustrates an exemplary environment suitable for practicing the present invention.

FIG. 2 is a flow chart illustrating a method for providing code coverage in a computer program, in accordance with an embodiment of the present invention.

FIG. 3 is an exemplary computer program wherein breakpoints are set on a class prepare event.

FIG. 4 shows an exemplary intermediate code coverage report corresponding to the exemplary computer program depicted in FIG. 3.

FIG. 5 shows an exemplary final code coverage report corresponding to the exemplary computer program depicted in FIG. 3.

### DETAILED DESCRIPTION OF EMBODIMENTS OF THE INVENTION

Embodiments of the invention provide a method, a system, and a computer program product for providing code coverage for programs coded in an Object Oriented Programming (OOP) language. The embodiments of the invention can be used for OOP languages that are characterized by classes defining properties, methods and events. The method and the system of the various embodiments of the invention can be used for choosing the classes for which the code coverage is desired.

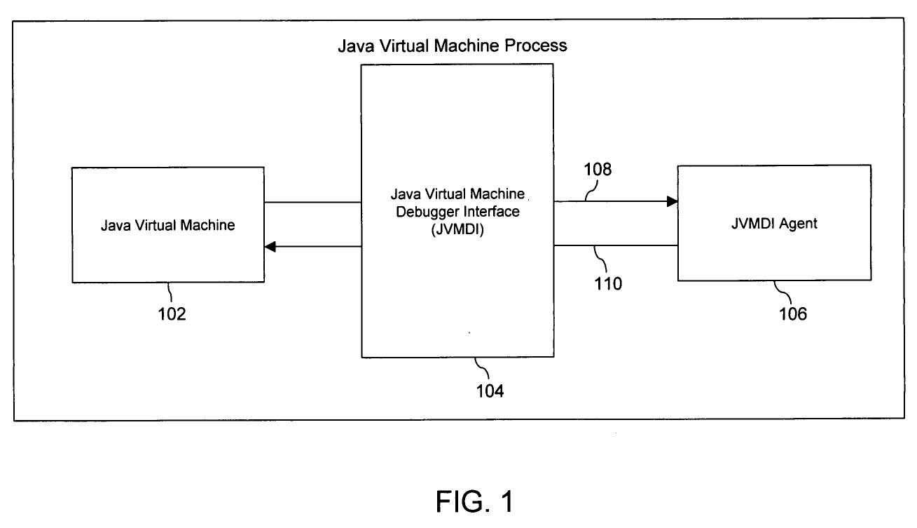

FIG. 1 illustrates an exemplary environment suitable for practicing the present invention. The exemplary environment includes a Java Virtual Machine 102, a Java Virtual Machine Debugger Interface (JVMDI) 104, and a JVMDI Agent 106. In various embodiments of the invention, each of Java Virtual Machine 102, JVMDI 104 and JVMDI agent (JCodeCoverage) 106 runs inside a Java Virtual Machine Process. JVMDI Agent 106 is communicatively coupled to Java Virtual Machine 102. Java Virtual Machine 102 generates events and communicates information about the events using path 108. JVMDI Agent 106 communicates control information to Java Virtual Machine 102 using path 110. Exemplary control information includes SetBreakpoint, ClearBreakpoint, ClearAllBreakpoint, GetClassMethods and GetSourceFileName.

JVMDI 104 acts as an interface to enable path 108 and path 110 between Java Virtual Machine 102 and JVMDI Agent 106. Java Virtual Machine 102 may generate events such as JVMDI_EVENT_BREAKPOINT, JVMDI_EVENT CLASS_PREPARE, JVMDI_EVENT_CLASS_LOAD, and other events related to Java Virtual Machine Debugger Interface. In various embodiments of the present invention, Java Virtual Machine 102 may also generate events unrelated to Java Virtual Machine Debugger Interface. JVMDI agent 106 may implement and register handler functions for the events generated by Java Virtual Machine 102. Control information about implementing and registering such handler functions may be communicated to Java Virtual Machine 102 using path 110. For example, the event JVMDI_EVENT_CLASS_LOAD may be generated by Java Virtual Machine 102 when a class is first loaded by Java Virtual Machine 102. JVMDI Agent 106 may implement a function for performing some computation when a class is first loaded. For example, a counter value may be incremented when a class is first loaded. JVMDI Agent 106 may register a handler function for the event JVMDI_EVENT_CLASS_LOAD with Java Virtual Machine 102. JVMDI Agent may define an object of the following struct type for defining a handler function

typedef struct {

jthread thread;
jclass clazz;

} JVMDI_class_event_data;

In an embodiment, JVMDI Agent 106 may be implemented as a native library on the platform on which Java Virtual Machine 102 maybe running. For example, JVMDI Agent 106 may be coded in a low-level language on the Microsoft Windows® platform and Java Virtual Machine 106 may be a Java Virtual Machine (JVM) or a Java Runtime Environment (JRE) provided by Sun Microsystems, Inc® for the Microsoft Windows® platform. Such a JVM or a JRE may be invoked by using a command similar to the following command on the command line available on the Microsoft Windows® platform:

C:\java\bin\java

The native library may be implemented as a Dynamic Link Library (DLL) on the Microsoft Windows® platform. For example, the native library may be coded in Microsoft® Visual C++® and may be called ‘tool.dll’. This DLL may be registered with the Microsoft Windows® operating system. The DLL may be attached to the JVM or JRE using a command similar to the following command on the command line available on the Microsoft Windows® platform

C:\java\bin\java -Xdebug -Xnoagent -Djava.compiler=NONE -Xruntool -
classpath . <class_file>

The above command may result in the JVM or JRE loading the native library ‘tool.dll’. The JVM may then find the implementation of a function JVM_OnLoad in the DLL. Subsequently, the JVMDI may process any command line options and set an event hook with SetEventHook. Once that event hook is called for the JVM initialization event, the JVMDI agent can complete its initialization. The ‘<class-file>’ in the above command may be the class file containing a class implementing the ‘Main’ function.

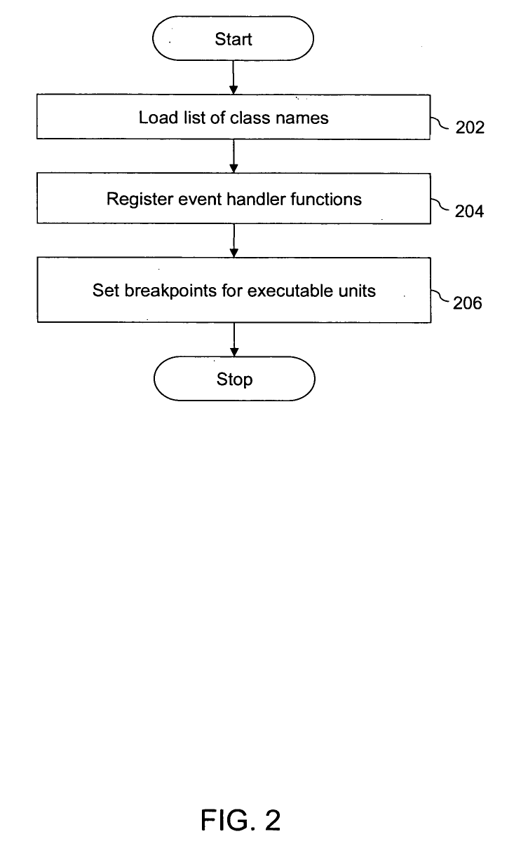

FIG. 2 is a flow chart illustrating a method for providing code coverage in a computer program, in accordance with an embodiment of the present invention. At step 202, a list of class names for which the code coverage is desired is loaded. The loading of the list of the class names may be implemented in the form of computer instructions in a language available on the platform on which Java Virtual Machine 102 is running. For example, a call back handler function JVM_OnLoad may contain the computer code resulting in loading the list of classes for which code coverage is desired. A text file may contain the list of class files that contain the classes for which the code coverage is desired. The call back handler function may parse the text file and identify the classes. At step 204, handler functions for events corresponding to the receiving of breakpoints and preparation of a class for loading may be registered with Java Virtual Machine 102. Java Virtual Machine 102 may generate events JVMDI_EVENT_BREAKPOINT and JVMDI_EVENT_CLASS_PREPARE in response to setting of breakpoints.

To summarize, the breakpoint is set in the class prepare event to receive break points events later during execution. Upon receiving a breakpoint event, a line hit counter is incremented thereby indicating which lines in the computer program have been exercised and which are not. Handler functions corresponding to these events may be registered with Java Virtual Machine 102.

At step 206, breakpoints for one or more executable units in each of the classes may be set in the function implementing the handler for the event corresponding to preparation of a class for loading. For example, in a handler function for the event JVMDI_EVENT_CLASS_PREPARE, a breakpoint may be set for one or more executable units in a class. An executable unit may be a group of instructions that are executed by the computer processor in its entirety. The setting of a breakpoint may cause the event JVMDI_EVENT_BREAKPOINT to be generated when Java Virtual Machine 102 encounters an executable unit for which the breakpoint is set. In various embodiments of the invention, steps 202, 204 and 206 may be implemented as computer instructions in JVMDI Agent 106.

Even though the steps of FIG. 2 have been described by using JVMDI events generated by Java Virtual Machine 102, any other events that correspond to preparing a class for loading and receiving breakpoints may be used. For example, Sun Microsystems, Inc. provides a JVM Tool Interface (JVM TI). JVM TI is a native programming interface for use by tools. It provides both a way to inspect the state, i.e., information related to the process such as value of the program counter, and to control the execution of applications running in the Java virtual machine. JVM TI supports the tools that need access to JVM state, including but not limited to: profiling, debugging, monitoring, thread analysis, and coverage analysis tools.

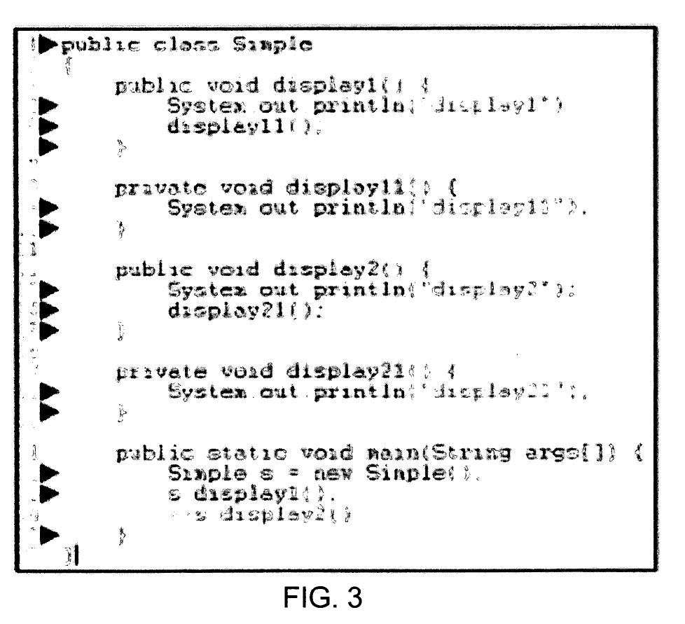

An exemplary computer program for which code coverage to be provided is depicted in FIG. 3. As shown in the figure, the breakpoints set on the class prepare event are depicted. In various embodiments of the invention, breakpoints can be set in the in-memory version of the class, i.e., in the byte code version.

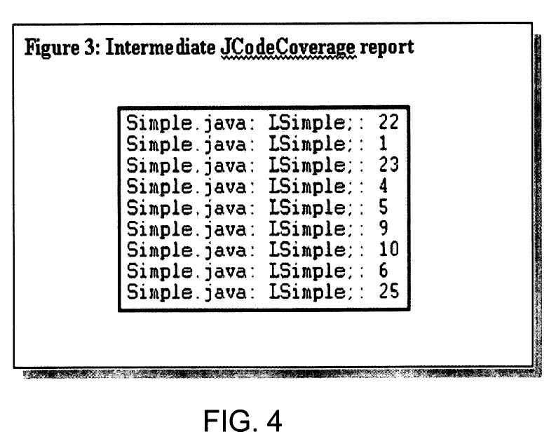

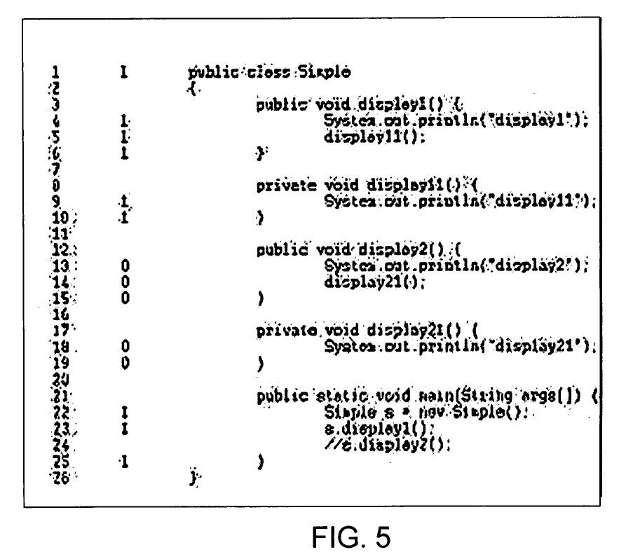

FIG. 4 depicts an intermediate code coverage report corresponding to the computer program depicted in FIG. 3. The final code coverage report is depicted in FIG. 5.

Embodiments of the present invention have the advantage that code coverage can be provided for a selected list of classes coded in an OOP language. The availability of such a selection of the classes leads to an enhanced debugging and testing environment.

Another advantage of embodiments of the present invention is that it is light-weight because various embodiments of the present invention are developed in a low-level language such as ‘C’. Such embodiments may be implemented as native libraries on the platform used for software development and testing. Thus, these libraries incur a reduced overhead and are optimized to the machine architecture. Also, various embodiments of the invention make use of JVMDI, which provides faster execution speeds than the tools developed, by using Java Debug Wire Protocol (JDWP) or Java Platform Debugger Architecture (JPDA).

Yet another advantage of embodiments of the present invention is that in embodiments of the invention, breakpoints are set for each of the executable units in the classes chosen for code coverage. In this way, the smallest unit of code can be covered.

Still another advantage of embodiments of the invention is that it does not make use of any third party libraries. This leads to an ease of use for code coverage because third party library dependencies are eliminated.

Another advantage of embodiments of the invention is that code instrumentation is not required. This leads to an ease of use for code coverage because source code modifications or recompilations of source code are eliminated.

Another advantage of embodiments of the invention is that standard programming interfaces available for any Java Virtual Machine can be used. This use of standard programming interfaces reduces Java Virtual Machine compatibility issues.

Another advantage of embodiments of the invention is that a code coverage report that may help in logging and reporting purposes can be provided.

Another advantage of embodiments of the present invention is that systems implementing the invention are easily attached to a Java Virtual Machine using a command line option.

Although the invention has been discussed with respect to specific embodiments thereof, these embodiments are merely illustrative, and not restrictive, of the invention. For example, a JVMDI agent may be a client program accessing the runtime environment using an interface. The client program can be implemented in conformance with specifications of any debugger interface for a runtime environment.

Although specific protocols have been used to describe embodiments, other embodiments can use other transmission protocols or standards. Use of the terms ‘peer’, ‘client’, and ‘server’ can include any type of device, operation, or other process. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification contains material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for synchronously presenting multiple video program ID streams, such as on a display screen of the computer, the computer would have suitable instructions (e.g., source code) for allowing a user to synchronously display multiple video program ID streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously presenting multiple video program ID streams, such as on a display screen, or for providing for input or presenting in accordance with various embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for providing code coverage for a program coded in a computer language, the computer language being used to code one or more classes, the classes being used to instantiate one or more objects, the classes defining methods to be performed on the objects, the classes further defining events to which the objects respond, the method comprising
loading a list of class names for which the code coverage is desired;
registering event handler functions for an event corresponding to the preparation of a class for loading and one or more breakpoints; and
receiving breakpoints for one or more executable units in each class from the list of classes,
wherein an environment for the computer language generates the events corresponding to the setting of the breakpoints and preparation of a class for loading.

2. The method of claim 1 wherein the computer language comprises Java.

3. The method of claim 2 wherein the event corresponding to the receiving of the breakpoint comprises JVMDI_EVENT_BREAKPOINT.

4. The method of claim 2 wherein the event corresponding to the preparation of a class for loading comprises JVMDI_EVENT_CLASS_PREPARE.

5. A native library for providing code coverage for programs coded in a computer language, the computer language being used to code one or more classes, the classes being used to instantiate one or more objects, the classes defining methods to be performed on the objects, the classes further defining events to which the objects respond, the native library containing computer code comprising one or more instructions for
loading a list of class names for which the code coverage is desired;
registering event handler functions for an event corresponding to the preparation of a class for loading and one or more breakpoints; and
receiving breakpoints for one or more executable units in each class from the list of classes,
wherein an environment for the computer language generates the events corresponding to the setting of the breakpoints and preparation of a class for loading.

6. The native library of claim 5 wherein the native library is attached to the environment for the computer language.

7. The native library of claim 5 wherein the computer language comprises Java.

8. The native library of claim 5 wherein the environment comprises a Java Virtual Machine.

9. The native library of claim 5 wherein the computer program is in ‘C’ language.

10. A machine-readable medium including instructions executable by the processor for providing code coverage in a computer language, the computer language being used to code one or more classes, the classes being used to instantiate one or more objects, the classes defining methods to be performed on the objects, the classes further defining events to which the objects respond, comprising one or more instructions for
loading a list of class names for which the code coverage is desired;
registering event handler functions for an event corresponding to the preparation of a class for loading and one or more breakpoints; and
setting breakpoints for one or more executable units in each class from the list of classes,
wherein an environment for the computer language generates the events corresponding to the setting of the breakpoints and preparation of a class for loading.

11. The machine readable medium of claim 10 wherein the computer language comprises Java.

12. The machine readable medium of claim 11 wherein the event corresponding to the receiving of the breakpoint comprises JVMDI_EVENT_BREAKPOINT.

13. The machine readable medium of claim 11 wherein the event corresponding to the preparation of a class for loading comprises JVMDI_EVENT_CLASS_PREPARE.
